(19) United States
(12) Patent Application Publication
(10) Pub. No.: US 2009/0198690 A1
(43) Pub. Date: Aug. 6, 2009

(54) INFORMATION COMPARISON METHOD

(75) Inventor: Yu-Jie Shi, Shanghai City (CN)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/025,491

(22) Filed: Feb. 4, 2008

(51) Int. Cl. G06F 17/30

(52) U.S. Cl. 707/6; 707/E17.014

(57) ABSTRACT

An information comparison method, suitable for a server, is provided. The server is connected to clients. The method includes following steps. First, assign at least two comparing objects among the server and the clients. Next, set a comparing information. Then, obtain the set comparing information from the comparing objects through the server. Afterwards, perform a comparing operation on the set comparing information according to formats of the obtained comparing information. And then, generate a comparing result.

### BACKGROUND OF THE INVENTION

1. Field of the Invention

The present invention is related to a comparison method, and particularly to an information comparison method.

2. Description of Related Art

A document comparator is a tool software used for checking and locating differences between text documents. Users may use the document comparator to compare two text documents, or compare differences among a plurality of text documents so as to mark those differences for the reference of users. Therefore, users no longer have to worry that it is difficult to determine if two or a plurality of text documents are completely identical. With the document comparator, differences between different text documents are easily located so as to facilitate management of these text documents.

Nowadays, functions of the document comparator are not only limited to simple comparison between text documents but also extended to support of complicated editing operation. A more advanced document comparator may even have a function which performs a text document overall comparison at a level of document folders. All the foregoing progressive functions greatly contribute to the convenience of the users. However, with the popularity of computers and the complication and diversification of information, that only information in text documents is compared but not a large amount of other information is similarly processed as well apparently no longer meets demands of users.

### SUMMARY OF THE INVENTION

The present invention is directed to an information comparison method capable of performing a comparing operation on a large amount of information in different formats.

The present invention is further directed to an information comparison method. In the information comparison method, a comparing information is set and the set comparing information is obtained from an assigned client through a server. Afterwards, a comparing operation is performed on the obtained comparing information.

The present invention provides an information comparison method suitable for use in a server. The server is connected to a plurality of clients. The comparison method includes following steps. First, at least two comparing objects are assigned among the server and the clients. Next, a comparing information is set. Afterwards, the set comparing information is obtained through the server from the comparing objects. Then, the set comparing information is compared according to formats of the obtained comparing information. Finally, a comparing result is generated.

According to an information comparison method of an embodiment in the present invention, when a comparing information is set, the information comparison method further includes setting the comparing information using an information database as reference. The information database includes all kinds of information suitable to be selected as the set comparing information of the comparing objects and formats and comparison methods of all the kinds of information.

According to an information comparison method in an embodiment of the present invention, the information comparison method further includes determining if information of at least one of the comparing objects is updated according to the comparing result. When it is determined to update the information, the information comparison method includes further judging whether the comparing object whose information is updated supports amending the information. When the comparing object whose information is updated is judged as supportive of amending the information, the information is then updated.

According to an information comparison method in an embodiment of the present invention, the server may obtain the set comparing information from the comparing objects by a long-distance retrieval.

In the present invention, at least two comparing objects are assigned among the server and the clients and the comparing information is also set. Afterwards, the set comparing information is obtained from the comparing objects through the server having authorization for access. Next, the set comparing information is compared according to formats of the obtained comparing information. Thus, in the present invention, a comparing operation is performed not only on the set comparing information, but also on a large amount of information in different formats. Then, according to the comparing results thus generated, the present invention completes the task it sets out to achieve.

In order to make the aforementioned and other objects, features and advantages of the present invention more comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of an information comparison method according to an embodiment of the present invention.

FIG. 2 is an operation flowchart of preserving comparing results.

FIG. 3 is a flowchart of relevant operation for updating information.

### DESCRIPTION OF EMBODIMENTS

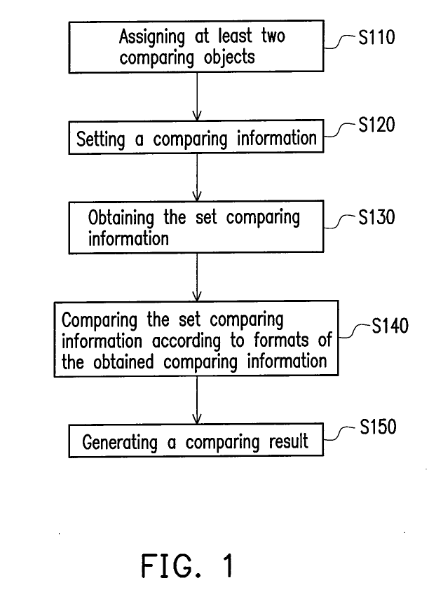

FIG. 1 is a flowchart of an information comparison method according to an embodiment of the present invention. The method illustrated in FIG. 1 may be applied in, for example, a server with a home server operating system. The so-called home server operating system is an operating system such as Windows Home Server, for example. Further, the server is also connected to a plurality of clients. The clients are not limited to computers. They may be electric appliances, like televisions, even refrigerators and so forth, as long as these electric appliances as the clients can provide comparing information and users can define the comparing information, such as a supply voltage, a consumption and the like.

Referring to FIG. 1, first, at least two comparing objects (as illustrated in a step S110) are assigned among a server and the clients.

Users may assign the server and one of the clients, or two of the clients as comparing objects. Users may even assign the server and a plurality of individuals among the clients to be compared with one another. Thereafter, the comparing information is set (as illustrated in a step S120). The set comparing information may be an information of a text document, an information of a multi-media document or a comparable information which the comparing objects can provide. If the comparing objects are two computer hosts, comparable information the two computer hosts can provide may be set for comparison. For example, configuration information of system software and hardware in the two computer hosts is set for comparison. If the comparing objects are two electric appliances, comparable information the two electric appliances can provide may be assigned for comparison. However, which kind of information is set for comparison mainly hinges on the comparable information the set comparing objects can provide. Certainly, when setting, both content and amount of the comparing information may be added or deleted by users according to actual situations.

Next, the set comparing information is obtained from the comparing objects through the server (as illustrated in a step S130). The server may obtain the set comparing information by a long-distance retrieval. If a home server operating system adopted by the server is Windows Home Server operating system, Windows Management Instrumentation (WMI) can be used to perform a long-distance retrieval. Certainly, if the set comparing information is obtained from the assigned client through the server, the server must have acquired authorization for access to the assigned client. Then, the set comparing information is compared according to the formats of the obtained comparing information (as illustrated in a step S140). Thereafter, a comparing result is generated (as illustrated in a step S150), and the comparing result is presented in statistics.

When setting the comparing information, users may further set the comparing information using an information database as reference. The information database includes all kinds of information suitable to be selected as the set comparing information of the comparing objects and formats and comparison methods of all the kinds of information. The information database may even preserve a collection of the comparable information of the server and the clients. Thus, users may use the information database to filter the information to be compared or even use the information database to provide a predetermined menu.

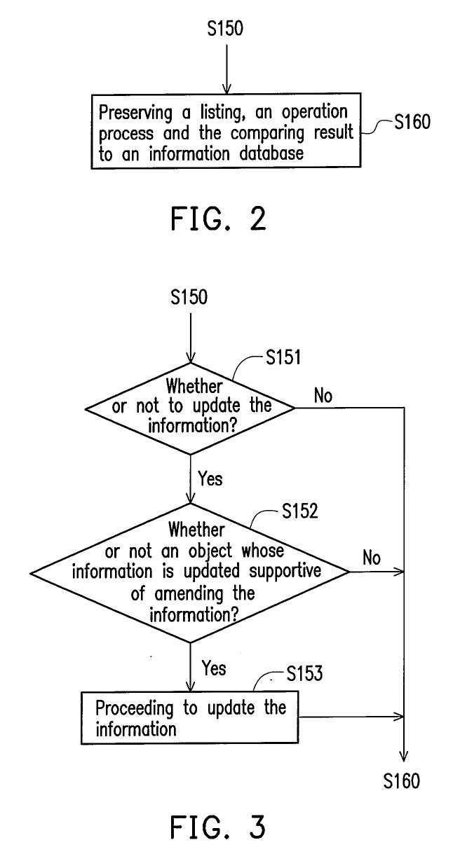

If users hope to preserve the comparing result, a flowchart illustrated by FIG. 2 may be referred to for operation. As illustrated in FIG. 2, after the comparing result is generated (i.e., the step S150 of FIG. 1), a listing, an operation process and the comparing result of the comparing information this time are preserved in the information database (illustrated as a step S160 in FIG. 2) for use the next time or in an identical operation.

In addition, the process of the information comparison method in the present invention may further include relevant operation of updating information, as illustrated in FIG. 3. Referring to FIG. 3, after the comparing result is generated (i.e., the step S150 of FIG. 1), according to the comparing result, it can be determined whether to update the information of at least one of the comparing objects (as a step S151 illustrated in FIG. 3). When it is determined not to update the information, the listing, operation process and comparing result of the comparing information this time are directly preserved in the information database (i.e., execution of the step S160 of FIG. 2). On the contrary, when it is determined to update the information, it is further judged whether an object whose information is updated supports amending the information (as a step S152 illustrated in FIG. 3). When the object whose information is updated is judged as not supportive of amending the information, the listing, operation process and comparing result of the comparing information this time are also directly preserved in the information database (i.e., execution of the step S160 of FIG. 2). On the contrary, when the object whose information is updated is judged as supportive of amending the information, the information is then updated.

Although in the foregoing description a server installed with a home version server operating system is used as an example, this example is not intended to limit the present invention. People of ordinary skill in the art should know that as long as the server has authorization to access the comparing objects and can obtain the comparing information from the comparing objects, the present invention can be implemented.

In summary, in the present invention, at least two comparing objects are assigned among the server and the clients, and the comparing information is set. Afterwards, the set comparing information is obtained from the comparing objects through the server having authorization for access. Next, the set comparing information is compared according to the formats of the obtained comparing information. Thus, in the present invention, the comparing operation is performed not only on the set comparing information, but also on a large amount of information in different formats. Then, the comparing result is generated therefrom.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An information comparison method, suitable for a server, which is connected to a plurality of clients, comprising:
assigning at least two comparing objects among the server and the clients;
setting a comparing information;
obtaining the set comparing information from the comparing objects through the server;
comparing the set comparing information according to formats of the obtained comparing information; and
generating a comparing result.

2. The information comparison method as claimed in claim 1, when setting the comparing information, further comprising setting the comparing information using an information database as reference, wherein the information database comprises all kinds of information suitable to be selected as the set comparing information of the comparing objects and formats and comparison methods of all the kinds of information.

3. The information comparison method as claimed in claim 2, wherein the information database further preserves a collection of comparable information of the server and the clients.

4. The information comparison method as claimed in claim 2, after generating the comparing result, further comprising preserving a listing, an operation process and the comparing result of the comparing information this time in the information database.

5. The information comparison method as claimed in claim 1, after generating the comparing result, further comprising:
determining whether to update information of at least one of the comparing objects according to the comparing result;
when determining to update the information, further judging whether an object whose information is updated supports amending the information; and
when judging the object as supportive of amending the information, proceeding to update the information.

6. The information comparison method as claimed in claim 5, if determined not to update the information, further comprising preserving a listing, an operation process and the comparing result of the comparing information this time in an information database.

7. The information comparison method as claimed in claim 5, when judging the object whose information is updated as not supportive of amending the information, further comprising preserving a listing, an operation process and the comparing result in an information database.

8. The information comparison method as claimed in claim 1, wherein the set comparing information comprises an information of a text document, an information of a multi-media document or a comparable information which the comparing objects can provide.

9. The information comparison method as claimed in claim 8, wherein the comparing objects are computers or other household appliances.

10. The information comparison method as claimed in claim 1, wherein the server obtains the set comparing information from the comparing objects by a long-distance retrieval.

11. The information comparison method as claimed in claim 1, wherein the comparing result is presented in statistics.

12. The information comparison method as claimed in claim 1, wherein the server is installed with a home version server operating system.
